(19) United States
(12) Patent Application Publication
(10) Pub. No.: US 2002/0182401 A1
(43) Pub. Date: Dec. 5, 2002

(54) Pad conditioner with uniform particle height

(76) Inventor: Andrew Scott Lawing, Phoenix, AZ (US)

Correspondence Address: Rodel Holdings, Inc., Suite 1300, 1105 North Market Street, Wilmington, DE, 19899, US

(21) Appl. No.: 09/872,249

(22) Filed: Jun. 1, 2001

(51) Int. Cl. B32B 5/16

(52) U.S. Cl. 428/323; 428/325; 428/332; 428/402; 428/403

(57) ABSTRACT

A pad conditioner for conditioning polishing pads that has precisely controlled abrasive particle positioning is formed using a temporary holding layer that establishes a uniform contact plane. The pad conditioners may be formed with multiple levels of contact planes that provide conditioning action at multiple heights occurring simultaneously. The pad conditioners may also be formed with a specified particle orientation, or with multiple sizes of particles.

### TECHNICAL FIELD

The field of the invention relates generally to polishing pad conditioners and specifically to pad conditioners with a well defined abrasive surface.

### BACKGROUND OF THE INVENTION

In the semiconductor industry, semiconductor wafers are planarized using a chemical mechanical polishing apparatus that presses the wafer surface against a polishing pad. As polishing continues, the surface of the polishing pad may become worn and the nature of the asperities on the surface of the polishing pad changes significantly such that the quality and efficiency of the polishing process is compromised. Accordingly, the polishing pad is conditioned or roughened (in situ or ex situ) via a device known as a pad conditioner. Typically the pad conditioner comprises one or more diamond particles at the surface of the pad conditioner. These particles provide an abrasive surface for roughening when they are pressed against the surface of the polishing pad.

Particles with large depths of penetration into the polishing pad contribute to accelerated wear of the pad. Pad wear can be minimized by controlling or limiting the penetration depth of the abrasive particles into the polishing pad. This can be achieved by physically limiting the effective dimensions of the abrasive particles by limiting the amount they protrude from the surface of the

Another method of controlling the penetration depth would be to tightly control the size distribution of the abrasive particles. A narrow size distribution of particles would result in abrasive point contacts of substantially the same height, such that the penetration depth of the abrasive particles into the polishing pad would be substantially uniform. Particle size control is achieved through a costly process of incremental sieving to refine the crystal size variation down to a tolerable range.

Penetration depth plays a significant role in the performance of a pad conditioner. Conditioners exhibiting a large mean penetration depth are generally very aggressive, result in rapid thinning of the polishing pad. These types of conditioners can be useful in a situation were it is desirable to perform very aggressive conditioning for a small amount of time, i.e. ex situ applications where the polishing pad is conditioned between wafers, and conditioning time reduces wafer throughput. On the other hand, since the wafer is only contacting the upper surface of the polishing pad, the surface morphology of interest is generated mostly by particles interacting at small penetration depths.

Combining particles of various controllable penetration depths to exploit their respective advantages while minimizing the disadvantages has not been feasible with conventional pad conditioners. PCT International Publication Number WO 99/41039 by Applied Materials, Inc. discloses an end effector for pad conditioning that is formed with the crystals embedded in a matrix material. This end effector allows for the use of smaller crystals. However the only mechanism to control the abrasive surface depth of the end effector is through particle size uniformity. The use of a mixture of particle sizes in this end effector would necessarily result in an uneven abrasive surface. The uneven surface would necessarily apply uneven force to the polishing pad during the conditioning process. As a result of the uneven applied force, the pad conditioner would fail to adequately condition the polishing pad in some regions, while simultaneously over-conditioning and substantially thinning the polishing pad in other regions.

There remains a need in the art to optimize and tailor the surface characteristics of various polishing pads. The relative height of abrasive particles has a major influence on their penetration into the pad, and therefore the aggressiveness of the conditioning action. The height of the diamond particles also has a profound affect on the surface texture of the polishing pad and therefore, polish performance. Precise control of the relative diamond height would provide precise control over the aggressiveness of the conditioning. Additionally, the long term stability of the conditioner is determined by the uniformity of the penetration depth distribution. Conditioners with an initially large distribution of penetration depths will wear unevenly over time, and the distribution of penetration depths, and correspondingly the applied pressure distribution as well as the consistency of the conditioning action, will become more broad as the conditioner becomes worn.

With precise control of the abrasive surface depth, a pad conditioner could be optimized and tailored for use with various polishing pads. The relative height of abrasive particles has a major influence on their penetration into the pad, and therefore the aggressiveness of the conditioning action. Precise control of the relative diamond height is required to control the aggressiveness of the conditioning as well as the stability of the pad conditioner. Additionally, the ability to precisely control relative abrasive particle height would enable the manufacture of “self-limiting” pad conditioners in which the penetration depth of the abrasive particles into the polishing pad materials is limited by the precisely controlled protrusion of the abrasive particles from the matrix in which they are imbedded, rather than the tedious control of the particle size. However, conventional fabrication techniques do not provide for making a pad conditioner with a uniform particle height.

### SUMMARY OF THE INVENTION

The present invention provides a pad conditioner with precisely controlled, and optionally multi-level, abrasive surface height. The pad conditioners of the present invention may have multiple discrete levels of conditioning action occurring simultaneously.

The invention includes a process for fabricating a pad conditioner. The process includes 1) distributing the abrasive particles on a flat surface; 2) depositing a temporary sacrificial holding layer material over the distributed abrasive particles to form a temporary holding layer; 3) applying a permanent holding material over the temporary holding layer and enveloping the abrasive particles to form a permanent holding layer completely covering the distributed abrasive particles; 4) separating the flat surface from the temporary layer to expose the bottom surface of the temporary holding layer; and 5) removing the temporary sacrificial holding layer from the permanent holding layer.

In one embodiment, the present invention involves the above process including additional steps of distributing a second set of abrasive particles over the temporary holding layer and depositing a temporary holding material over the distributed second set of abrasive particles to form a second temporary holding layer. The combined thickness of the first and second temporary layers is less than half the mean size of the first layer of abrasive particles. This process further includes applying a permanent holding material over the second temporary holding layer to envelope the first and second sets of abrasive particles and to form a permanent holding layer completely covering the distributed abrasive particles, and separating the flat surface from the temporary layer. Finally, the process includes removing the temporary holding layers from the permanent holding layer and exposing the permanent holding layer and a portion of the abrasive particles.

In an alternate embodiment, the present invention provides a pad conditioner with predetermined abrasive particle protrusion length. This pad conditioner comprises: a substrate; a permanent holding layer attached to the substrate; abrasive particles imbedded in the permanent holding layer (these abrasive particles have a distribution of sizes); and a contact plane at a uniform distance from the permanent holding layer. The abrasive particles of the pad conditioner protrude and extend from the permanent holding layer to define the contact plane at a uniform distance from the permanent holding layer.

Another pad conditioner of this invention also has predetermined abrasive particle height and protrusion and comprises: a substrate; a permanent holding layer attached to the substrate; a first set of abrasive particles imbedded in the permanent holding layer. This first set of abrasive particles has ends that protrude from the permanent holding layer, and the ends define a contact plane at a predetermined distance from the permanent holding layer. A second set of abrasive particles is also imbedded in the permanent holding layer. This second set of abrasive particles has ends that protrude from the permanent holding layer, and the ends of the second set of abrasive particles define a second contact plane at a predetermined distance from the permanent holding layer. The second contact plane is at a greater distance from the permanent holding layer then the first contact plane.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIGS 1a, 1b, 1c, 1d, and 1e schematically show process steps in forming a pad conditioner according to the present invention.

FIGS. 2a, 2b, 2c, 2d, and 2e schematically show process steps in forming a pad conditioner with multi-modal particle sizes according to the present invention.

FIGS. 3a, 3b, 3c, 3d, 3e and 3f schematically show process steps in forming a pad conditioner with multi-levels according to the present invention.

FIG. 4 schematically shows a pyramidal particle for use in the present invention.

FIG. 5 illustrates an example of an alternative particle shape for use in the present invention.

FIG. 6 schematically shows a method of aligning particles in a preferred orientation and at a uniform protrusion according to the present invention.

### DETAILED DESCRIPTION OF THE INVENTION

The pad conditioner, and the process of making the pad conditioner, as described here provides an abrasive surface in which the abrasive particles are at a precisely controlled height relative to a reference plane. Abrasive particles of different sizes can be accurately aligned at the same protrusion height, or alternatively, a protrusion height distribution can be designed with abrasive particles of the same or differing sizes. The abrasive particle height is precisely controlled by placing the abrasive particles on a flat surface and fixing them in place with a temporary sacrificial material, before a permanent holding layer is deposited. Multiple layers of sacrificial material can be built up to provide a multi-modal height distribution. The abrasive particles are ultimately fixed in place permanently with a matrix material. After the matrix material has been attached to a substrate, the sacrificial material, which defines the protrusion height, can be removed.

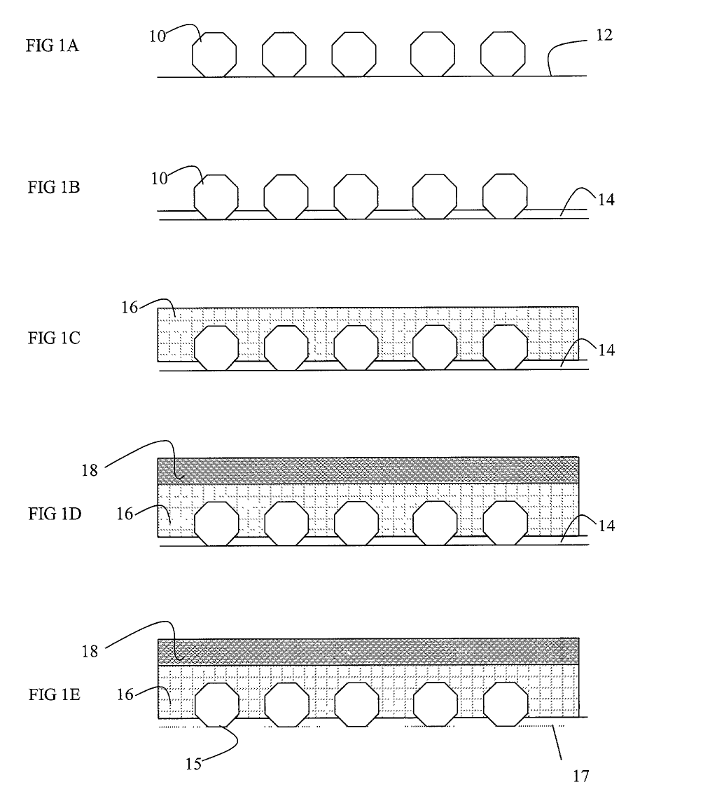

Referring now to the drawings, wherein like reference numerals refer to like elements throughout, FIG. 1a shows a plurality of abrasive particles (10) on a flat surface (12). According to the present invention the abrasive particles (10) are placed on a substantially flat surface (12), which serves as the reference plane. The flat surface arranges the abrasive particles to form a contact plane equiplanar with the flat surface. The flat surface may be any substantially flat level platform, and preferably is resistant to deflection. FIG. 1b shows a temporary sacrificial holding layer (14), that has been deposited over the flat surface. The particles are held in place with this temporary layer of sacrificial material. A screen, grid or other template can be used to hold the particles in a desired orientation, or to define a desired distribution of particles. Any means to arrange the abrasive particles on a regular geometric pattern may be used. Such a template can be used before the temporary holding layer is deposited, or embedded in the sacrificial material to hold the particles is the desired position. The temporary sacrificial holding layer material may comprise any suitable holding material, such as a wax, or a soluble polymer.

A permanent holding material is applied over the temporary holding layer (14), as shown in FIG. 1C. The material covers the abrasive particles to form a permanent holding layer (16) completely covering the distributed abrasive particles. The permanent holding material can be any material capable of maintaining the particles in place while having sufficient resistance to abrasion such that the material does not wear too quickly. The hardness or abrasion resistance of the abrasive particles and the matrix may also be tailored in combination to maintain a desired protrusion distance. The permanent holding layer material may comprise nickel, a braze alloy, or a sintering alloy material.

The solidified permanent holding layer (16) may be attached to a substrate (18), as shown in FIG. 1d. The substrate is preferably made of a corrosion resistant material, such as stainless steel, and is suitable for mounting in conditioning instruments, or polishing machines. The flat surface (12) is separated from the temporary holding layer (14) to expose the bottom surface of the temporary holding layer, and the temporary holding layer is removed, as shown in FIG. 1e. The temporary holding material can either be dissolved or otherwise removed (as in the case of a soluble polymer) or may be volatilized in the process of consolidating the permanent holding layer through exposure to elevated temperature as is typically encountered in a brazeing or sintering process. A corrosion barrier such as a diamond, diamond-like carbon, metal alloy (including Ni, Co, Cr, Al and Fe alloys) or other corrosion resistant film can be applied to the exposed matrix after the sacrificial layer is removed to protect the permanent holding layer from corrosion. The corrosion barrier is generally applied after the permanent holding layer has been consolidated.

The particle contact points (15) form a contact plane (17) at a uniform distance from the permanent holding layer. A pad conditioner according to this invention enables various abrasive particle surface configurations that are advantageous for chemical mechanical polishing (CMP) pad conditioning and are unattainable with previous methods.

The abrasive particles shown in FIGS. 1a-1e have substantially uniform size. These particles are positioned at a precise and uniform height and protrusion by the temporary holding layer. The thickness of the temporary holding layer determines the height and protrusion of the particles, and can be tailored for specific applications. While the thickness of the temporary holding layer is limited only by the constraint of permitting enough abrasive particle for the permanent holding matrix to securely affix the particles, the temporary holding layer for the embodiment shown in FIGS. 1a-e has a thickness less than half of the minimum thickness of the abrasive particles. The temporary holding layer material preferably has a thickness between 20%-75% of the mean size of the abrasive particles, and the mean size of the abrasive particles is preferably less than about 500 μm. The abrasive particles can be any particle of a hardness substantially greater than the material to be conditioned. In fact, tailoring the hardness of the particle to a specific pad platform could be a way to control the conditioning behavior. The preferred abrasive particles for many pad conditioning applications are diamonds.

By establishing a precise abrasive surface plane on the pad conditioner, the conditioning process provides more uniform conditioning without excessive pad wear in some areas, and insufficient conditioning in other areas, as seen with typical pad conditioners. The uniform particle height and protrusion of the present pad conditioner provides longer pad and pad conditioner lifetimes.

The pad conditioners resulting from the process described above and illustrated in FIGS. 1a-c have a permanent holding layer (optionally attached to a substrate) with abrasive particles imbedded in the permanent holding layer, and a contact plane at a uniform distance from the permanent holding layer.

Because the uniform distance of the contact plane is determined by the thickness of the temporary holding layer, the uniform distance is typically between 20% and 75% of the mean size of the abrasive particles, although it may be advantageous to limit the protrusion heights to very small values, between about 0 μm and 10 μm, for specific applications. The abrasive particles are preferably between about 50 μm and 500 μm in diameter and are uniformly spaced on the permanent holding layer. The abrasive particles may be distributed with a pre-determined distance between the particles, typically about 400-1000 μm center-to-center.

Although the invention is described herein in the context of conventional brazed diamond conditioning technology, it is not limited to that form. The same process can be applied to other material configurations.

The present invention also provides for the manufacture of pad conditioners with abrasive particles that have significant deviations in size. Abrasive particles typically have a distribution of sizes around a mean size. The degree of distribution is determined by the degree of rigor used in the size selection refinement process. To obtain particles of uniform size, a very small size distribution is required, and thus very rigorous size selection refinement is required. This costly size selection refinement process can be eliminated while a precise and uniform protrusion height is maintained using the process of the present invention.

The abrasive particles illustrated in FIGS. 1a-1e, have substantially the same size. However, the pad conditioners of the present invention may be formed using abrasive particles of different sizes or morphology. Diamonds of different morphology, for example, can provide characteristically different cutting patterns, and hence different polishing pad surface morphologies. The present invention allows the use of different size abrasive particles, and thus provides the advantage of manipulating pad morphology with the use of various particle sizes. The abrasive surface contact plane remains equiplanar with the initial flat surface even though the abrasive particle sizes vary significantly.

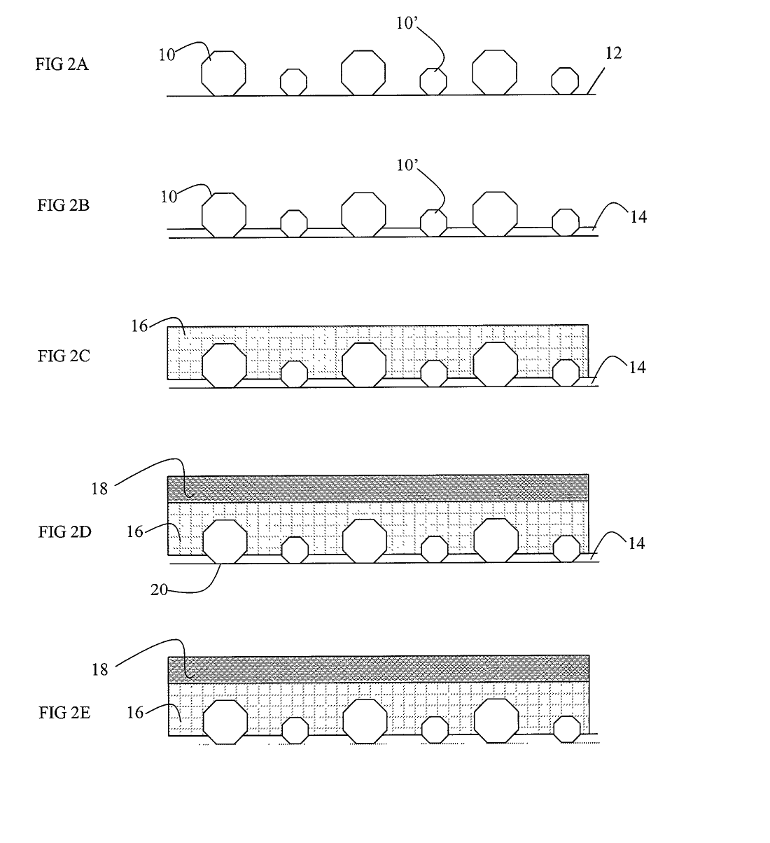

FIGS. 2A-2E illustrate an embodiment of the present invention which provides a pad conditioner with a bi-modal abrasive particle size distribution. The particles of both size modes are held at a precise and uniform height and protrusion. This particular configuration would be unobtainable by conventional manufacturing methods. This configuration would yield a unique pad surface due to the different cutting characteristics of the different size abrasive particles.

FIG. 2A shows abrasive particles (10 and 10′) distributed on a flat surface (12). These particles have a distribution of sizes around two substantially distinct pre-selected mean sizes. In a manner similar to that described above, a temporary holding material (14) is deposited over the flat surface (12) to a thickness that determines the particle protrusion height, as shown in FIG. 2B. The temporary holding layer material typically has a thickness greater than half of the minimum mean size. The mean size of the particles refers to the size value that is midway between the extreme sizes of the distribution of particle sizes. The limits of the temporary holding layer are primarily dictated by the size of the particles and the temporary layer must provide a large enough portion of the particle available to the permanent holding material matrix to adequately adhere the smallest particles.

The permanent holding material (16) is then deposited over the temporary holding layer (FIG. 2C), and a substrate (18) may be attached to the permanent holding layer as shown in FIG. 2D. A corrosion resistant barrier can then be applied to the exposed surface of the particles (20) and the temporary holding layer removed, as shown in FIG. 2E.

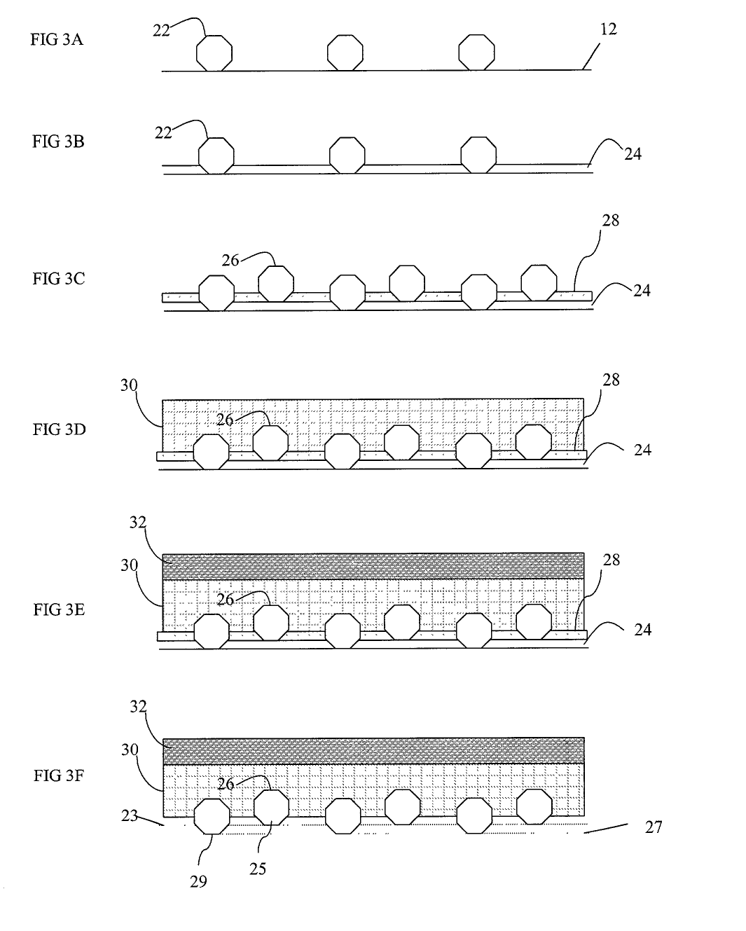

In still another embodiment, successive layers of abrasive particles and sacrificial material are built-up as illustrated in FIGS. 3A-3F, to yield a controlled multi-level structure. The example of a multi-level abrasive particle configuration shown in FIGS. 3A-3F contain abrasive particle that have a limited size distribution around a pre-selected mean size. FIGS. 3A and 3B show the first layer of particles (22) distributed and held in place by a layer of temporary holding material (24) in a similar manner as in FIGS. 1 and 2. However in this embodiment, a second layer of abrasive particles (26) is placed at a precise and uniform height that is offset from the flat surface (12) by a height equal to the thickness of the first sacrificial layer (24). FIG. 3C illustrates the distribution of a second layer of particles (26) and the deposition of a second temporary holding layer (28). This same procedure could be repeated to yield multiple levels if desired. The deposition of a permanent holding layer (30) and the optional attachment to a substrate (32) shown in FIGS. 3D and 3E are as described above. The removal of the temporary holding layers, as shown in FIG. 3F, reveals particles at multiple, precise abrasive surface heights. The abrasive surface heights provide multiple contact planes (23, 27), formed by the particle contact points (25, 29) As discussed above, this configuration yields unique pad morphologies due to the differing penetration depths of the diamonds at each level. This configuration allows more stable, controllable and reproducible pad conditioning than using a broad particle size distribution at one continuous level.

The combined thickness of the first and second temporary layers is preferably less than half the mean size of the first layer of abrasive particles, but similar to the previously described embodiments, the thickness of the temporary layers are limited only by the particle size and the dimensions required for adequate adhesion to the permanent holding, but will typically be less than 250 μm thick, and the abrasive particles typically have an effective diameter less than about 500 μm.

The permanent holding layer over the second temporary holding layer covers the first and second sets of abrasive particles holding both sets of abrasive particles. If multiple layers of abrasive particles are used, the permanent holding layer will cover and adhere to all the layers of abrasive particles to a thickness of approximately 50% of the largest particle diameter.

There are also advantages to using distinct particles sizes for the various layers of abrasive particles. The first set of abrasive particles may have a size distribution about a first mean size, for example a large particle size, and the second set of abrasive particles may have a second mean size, such as a small particle size. The number of particles in each layer could also vary to optimize the polishing pad surface morphology and the corresponding polish behavior.

This type of particle organization would promote limited pad removal by relatively few large particles in the first layer, while simultaneously providing adequate surface polishing contacts with a greater number of small particles.

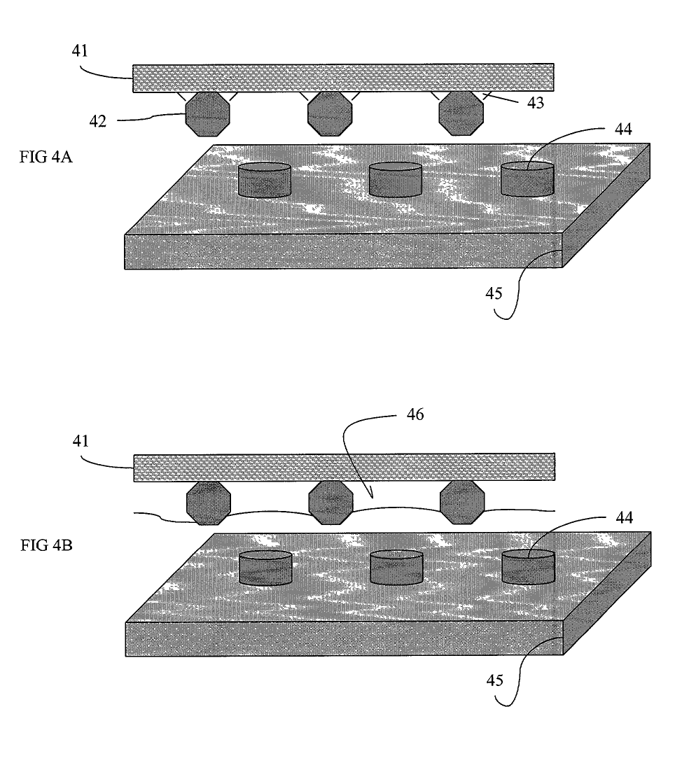

The present invention provides the ability to precisely control relative abrasive particle height which enables the manufacture of “self-limiting” pad conditioners. Self-limiting pad conditioners limit the penetration depth of the abrasive particles into the polishing pad materials by limiting the protrusion of the abrasive particles from the matrix. FIGS. 4A and 4B contrast the differences between conventional (FIG. 4A) and self-limiting (FIG. 4B) pad conditioning. In conventional conditioning, abrasive particles (42) are fixed to a substrate (41) with a relatively small amount of material (43). On fixed abrasive polishing pads, fixed abrasive posts (44) are situated on a pad substrate (45). Typically, the diamond particles have a larger dimension (on the order of 150 μm) than the fixed abrasive post (typically 40 μm high by 200 μm wide). As such, the abrasive particles (42) can destroy the fixed abrasive post (44) as the two protrusions are brought into contact under typical conditioning pressures and relative velocities.

In contrast, a self-limiting pad conditioner consists of abrasive particles fixed to a substrate with the abrasive particles covered in a matrix to a substantial depth such that only a small fraction of the abrasive particles are exposed beyond the matrix. In this manner, the penetration depth of the abrasive particles into the polishing pad is limited by the protrusion of the abrasive particles from the matrix.

In self-limiting conditioning, the amount of protrusion of the abrasive particle (48) is physically limited by a thicker matrix layer (46) that obscures all but a small fraction of the particle. In this manner, the amount of interference between the abrasive particle and the fixed abrasive post is limited, and the risk of destroying or dislodging the fixed abrasive post (44) on the polishing pad is significantly reduced. This embodiment of the present invention is particularly suited to a fixed abrasive application, where damage to the abrasive posts in the fixed abrasive film can be caused by large abrasive particles in a conventional pad conditioner. In the present invention, the protrusion of the abrasive particles is controlled with the thickness of the temporary holding layer. A relatively thin temporary holding layer provides abrasive particles that are largely immersed in the permanent holding matrix. In self-limiting applications, the temporary layer is typically less than 30 μm thick.

The protrusion can be limited with the present invention to such an extent that the conditioning action is suppressed. This configuration would be advantageous for applications such as fixed and embedded abrasives, where overly aggressive conditioning is detrimental.

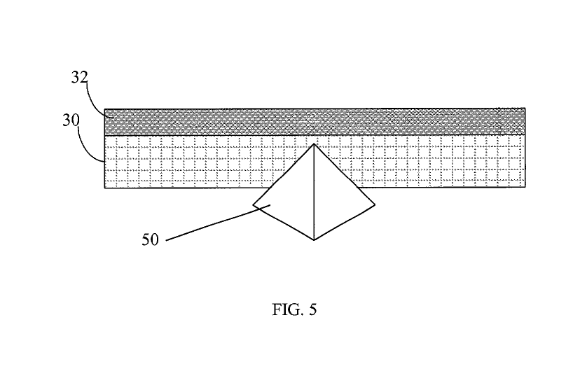

FIG. 5 illustrates a unique cutting edge that is obtainable with the present invention. A pyramidal crystal (50) can be fixed by this method, such that the resulting cutting edge is similar to a “cow catcher.” This shape is distinctive in that it is wider at the cutting tip than at the base. This provides a unique pad surface morphology that is otherwise difficult to obtain.

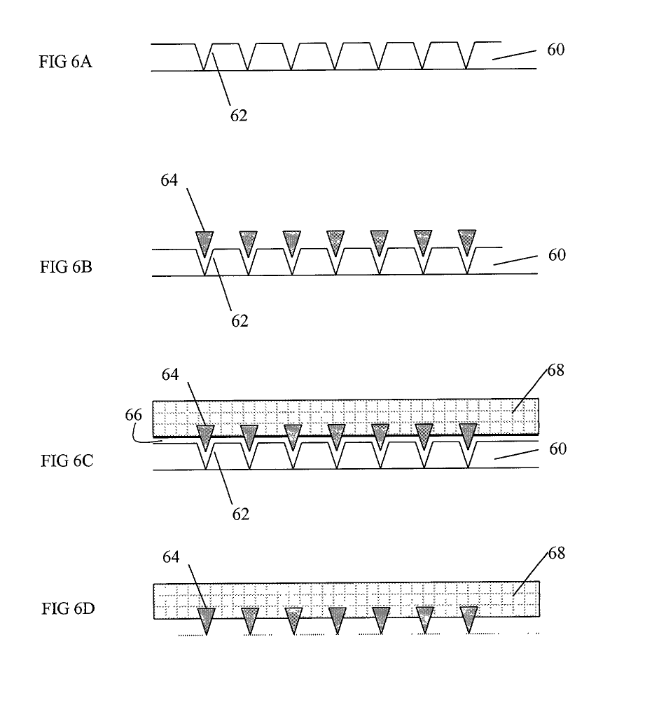

FIGS. 6A-6D Illustrate another embodiment of the present invention, in which the flat surface has particle orientation elements, which arrange the abrasive particles on the surface such that the particles are in a desired orientation. FIG. 6A illustrates an exemplary flat surface (60) with orienting elements (62). Pre-selected particles (64) are distributed on the surface and arranged in the distribution and positional orientation prescribed by the orienting elements (62) of the surface, as shown in FIG. 6B. A temporary holding layer (66) is deposited over the arranged abrasive particles to establish the protrusion of the particles, and a permanent holding layer (68) is subsequently deposited in a similar manner as previously presented, and shown in FIGS. 6C and D. A flat surface with orienting elements may be used in combination with any of the previously described embodiments as an additional component in optimization of the pad conditioner cutting morphology.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A process for fabricating a pad conditioner comprising a support, and a plurality of abrasive particles fixed to the support; the method comprising:
A. distributing the abrasive particles on a flat surface;
B. depositing a temporary holding layer material over the distributed abrasive particles to form a temporary holding layer;
C. applying a permanent holding material over the temporary holding layer and enveloping the abrasive particles to form a permanent holding layer completely covering the distributed abrasive particles;
D. separating the flat surface from the temporary layer to expose the bottom surface of the temporary holding layer; and
E. removing the temporary holding layer from the permanent holding layer.

2. The process according to claim 1 wherein the flat surface is resistant to deflection

3. The process according to claim 1 wherein the flat surface arranges the abrasive particles to form a contact plane equiplanar with the flat surface.

4. The process according to claim 1 wherein during step A, the abrasive particles are distributed over the flat surface using an abrasive particle orienting element.

5. The process according to claim 1 wherein a means to arrange the abrasive particles into a regular geometric pattern is juxtaposed to the flat surface incorporate prior to step A.

6. The process according to claim 1 wherein step E further comprises:
attaching a substrate to the permanent holding layer.

7. The process according to claim 1 wherein the abrasive particles have a distribution of sizes around a mean size.

8. The process according to claim 7 wherein the temporary holding layer material has a thickness between 20%-75% of the mean size of the abrasive particles.

9. The process according to claim 7 wherein the mean size of the abrasive particles is less than about 500 μm.

10. The process according to claim 1 wherein the abrasive particles have a distribution of sizes around two or more substantially different mean sizes.

11. The process according to claim 1 wherein the temporary holding layer has a thickness less than 30 μm.

12. The process according to claim 1 wherein the temporary holding layer material comprises a wax, a soluble polymer or a metal.

13. The process according to claim 1 wherein the permanent holding layer material comprises a brazing or a sintering alloy material.

14. The process according to claim 13 wherein the permanent holding layer material comprises nickel or a nickel-based alloy.

15. The process according to claim 6 wherein the substrate comprises a corrosion resistant material.

16. The process according to claim 15 wherein the substrate comprises stainless steel.

17. The process according to claim 1 wherein the abrasive particles are diamonds.

18. The process according to claim 1 wherein the abrasive particles are cubic boron nitride.

19. The process according to claim 1 further comprising, after step E; applying a corrosion barrier to the surface of the permanent holding layer.

20. The process according to claim 19 wherein the corrosion barrier comprises a material selected from the group consisting of: diamond, diamond-like carbon material, ceramic material, pure metal and metal alloy.

21. A process for fabricating a pad conditioner comprising a support and abrasive particles fixed to the support; the method comprising:
A. distributing the abrasive particles on a flat surface.
B. depositing a temporary holding material over the distributed abrasive particles on the flat surface to form a temporary holding layer having a thickness less than the minimum thickness of the abrasive particles, said temporary holding layer having a bottom surface adjacent the flat surface and a top surface, opposite the bottom surface, the temporary holding material comprising a wax, a soluble polymer, or a metal;
C. applying a permanent holding material over the top surface of the temporary holding layer, the permanent holding material covering the abrasive particles to form a permanent holding layer over the distributed abrasive particles and the temporary holding layer, the permanent holding layer has a first surface adjacent the temporary holding layer and a second surface opposite the first surface;
D. removing the flat surface from the temporary layer to expose the bottom surface of the temporary holding layer and the abrasive particles therein;
E. attaching a substrate to the second surface of the permanent holding layer, wherein the substrate comprises a corrosion resistant material;
F. removing the temporary holding layer from the permanent holding layer thereby exposing the first surface of the permanent holding layer and a portion of the abrasive particles therein; and
G. applying a corrosion barrier to the exposed first surface of the permanent holding layer and the abrasive particles therein.

22. A process for fabricating a pad conditioner comprising a support and a plurality of abrasive particles fixed to the support, the abrasive particles having a size distribution about a mean size; the method comprising:
A. distributing a first set of abrasive particles on a substantially flat surface;
B. depositing a temporary holding material over the distributed first set of abrasive particles on the flat surface to form a first temporary holding layer;
C. distributing a second set of abrasive particles over the first temporary holding layer;
D. depositing temporary holding material over the distributed second set of abrasive particles to form a second temporary holding layer, the combined thickness of the first and second temporary layers being less than the mean size of the first set of abrasive particles;
E. applying a permanent holding material over the second temporary holding layer to cover the first and second sets of abrasive particles and to form a permanent holding layer over the distributed abrasive particles;
F. separating the flat surface from the first temporary layer to expose the bottom surface of the first temporary holding layer; and
G. removing the first and second temporary holding layers from the permanent holding layer exposing the first surface of the permanent holding layer and a portion of the abrasive particles.

23. The process according to claim 22 further comprising a step before step G; attaching a substrate to the permanent holding layer.

24. The process according to claim 22 wherein the first and second sets of abrasive particles have substantially the same mean size.

25. The process according to claim 22 wherein the first set of abrasive particles has a size distribution about a first mean size and the second set of abrasive particles has a second mean size.

26. The process according to claim 25 wherein the first mean size is greater than 200 μm, and the second mean size is less than 200 μm.

27. The process according to claim 22 wherein an abrasive particle orienting element is employed in step A to distribute the first set of abrasive particles.

28. The process according to claim 22 wherein the first temporary layer has a thickness of less than 30 μm.

29. The process according to claim 22 wherein the abrasive particles have a mean size less than about 500 μm.

30. The process according to claim 22 wherein the temporary holding layer material comprises a wax, a soluble polymer, or a metal.

31. The process according to claim 22 wherein the permanent holding layer material comprises a brazing or a sintering alloy material.

32. The process according to claim 22 wherein the substrate comprises a corrosion resistant material.

33. The process according to claim 22 wherein the abrasive particles are diamonds, or cubic boron nitride.

34. The process according to claim 22 further comprising a step:
H. applying a corrosion barrier to the exposed first surface of the permanent holding layer and the abrasive particles therein.

35. The process according to claim 22 further comprising a step, before step E; distributing additional sets of abrasive particles and applying additional temporary holding layers.

36. A pad conditioner with predetermined abrasive particle protrusion length comprising:
A. a substrate;
B. a permanent holding layer attached to the substrate;
C. abrasive particles imbedded in the permanent holding layer; and
D. a contact plane at a uniform distance from the permanent holding layer, said contact plane being formed by contact points of the abrasive particles.

37. The pad conditioner of claim 36 wherein the abrasive particles have a mean size and the uniform distance is between 20% and 60% of the mean size of the abrasive particles.

38. The pad conditioner of claim 36 wherein the uniform distance is less than about 100 μm.

39. The pad conditioner of claim 36 wherein the substrate comprises a corrosion resistant material.

40. The pad conditioner of claim 36 wherein the permanent holding layer comprises a brazing or a sintering alloy material.

41. The pad conditioner of claim 36 wherein the abrasive particles comprise diamonds, or cubic boron nitride.

42. The pad conditioner of claim 36 wherein the abrasive particles have a mean size and the mean size is less than about 300 μm.

43. The pad conditioner of claim 36 wherein the permanent holding layer has a corrosion barrier applied thereto.

44. The pad conditioner of claim 36 wherein the abrasive particles are uniformly spaced in the permanent holding layer.

45. The pad conditioner of claim 44 wherein the abrasive particles are distributed with about 400-1000 μm between the particles, center-to-center.

46. The pad conditioner of claim 36 wherein the abrasive particles are uniformly oriented in the permanent holding layer.

47. A pad conditioner with predetermined abrasive particle height and protrusion comprising:
A. a substrate;
B. a permanent holding layer attached to the substrate;
C. a first set of abrasive particles imbedded in the permanent holding layer, wherein the first set of the abrasive particles have contact points that protrude from the permanent holding layer, the contact points of the abrasive particles define a contact plane at a predetermined distance from the permanent holding layer; and
D. a second set of abrasive particles imbedded in the permanent holding layer; the second set of abrasive particles have contacts points that protrude from the permanent holding layer, and the contact points of the second set of abrasive particles define a second contact plane at a predetermined distance from the permanent holding layer.

48. The pad conditioner of claim 47 wherein said second contact plane is at a greater distance from the permanent holding layer then the first contact plane.

49. The pad conditioner of claim 47 wherein the first set and the second set of abrasive particles have a substantially similar mean size.

50. The pad conditioner of claim 47 wherein the first and the second sets of abrasive particles have substantially different mean sizes.

51. The pad conditioner of claim 47 further comprising additional abrasive particles imbedded in the permanent holding layer; these additional abrasive particles have contact points that protrude from the permanent holding layer, and the contact points of the additional abrasive particles define an additional contact plane at a predetermined distance from the permanent holding layer.

52. The pad conditioner of claim 51 wherein the additional contact plane is less than 100 μm from the permanent holding layer.

53. The pad conditioner of claim 47 wherein the substrate comprises a corrosion resistant material.

54. The pad conditioner of claim 47 wherein the abrasive particles comprise diamonds, or cubic boron nitride.

55. The pad conditioner of claim 47 wherein the abrasive particles are less than about 500 μm in size.

56. The pad conditioner of claim 47 wherein the abrasive particles are uniformly spaced on the permanent holding layer.

57. The pad conditioner of claim 56 wherein the abrasive particles are distributed in the permanent holding layer with about 200-1000 μm between the particles, center-to-center. 58. The pad conditioner of claim 47 wherein the abrasive particles are uniformly oriented in the permanent holding layer.
